(19) United States
(12) Patent Application Publication
(10) Pub. No.: US 2014/0096268 A1
(43) Pub. Date: Apr. 3, 2014

(54) INFORMATION PROCESSING APPARATUS, DATA RETURNING METHOD AND STORAGE MEDIUM

(71) Applicant: Kabushiki Kaisha Toshiba, Tokyo (JP)

(72) Inventors: Eiji Tokita, Kawasaki-shi (JP); Masato Shimano, Yokohama-shi (JP); Yoshiyuki Tsuzuki, Koza-gun (JP); Isao Takeyasu, Yokohama-shi (JP); Masaaki Miki, Yokohama-shi (JP); Go Fujino, Kiyose-shi (JP)

(73) Assignee: KABUSHIKI KAISHA TOSHIBA, Tokyo (JP)

(21) Appl. No.: 14/012,708

(22) Filed: Aug. 28, 2013

Related U.S. Application Data
(63) Continuation of application No. PCT/JP2013/052387, filed on Feb. 1, 2013.

(30) Foreign Application Priority Data
Sep. 28, 2012 (JP) 2012-216295

(51) Int. Cl. G06F 21/62

(52) U.S. Cl. CPC G06F 21/62
USPC 726/28

(57) ABSTRACT

According to one embodiment, an information processing apparatus provides a data storage service via a network for storing data of a user. The apparatus includes a recipient setting module and an account issuing module. The recipient setting module is configured to accept and set a recipient of data and recipient-receivable data, designated by the user. The account issuing module is configured to issue an account to the recipient set by the recipient setting module. The account has an access right for enabling the recipient to access the recipient-receivable data.

### CROSS REFERENCE TO RELATED APPLICATIONS

This application is a Continuation Application of PCT Application No. PCT/JP2013/052387, filed Feb. 1, 2013 and based upon and claiming the benefit of priority from Japanese Patent Application No. 2012-216295, filed Sep. 28, 2012, the entire contents of all of which are incorporated herein by reference.

### FIELD

Embodiments described herein relate generally to an information processing technique suitable for information processing apparatuses used as servers that provide various services through, for example, the Internet.

### BACKGROUND

Various services have recently been offered via the Internet. For instance, a service called, for example, a storage service lends a space for storing data. If this service is used, it becomes unnecessary to, for example, further buy a storage device in accordance with an increase in data to hold. Further, if a user is in an Internet-connectable environment, data reading and storing is possible even when, for example, they are out or moving. In addition, data can be transferred to someone if a data access right is imparted to them.

Recently, not only business enterprises but also individuals have come to draw increasing attention to data security, and therefore it is considered that there is an increasing need for data storage services, like rental safes for important papers, that enable general users to store data without anxiety.

However, in such storage services as merely lending spaces for storing data, user themselves cannot designate, before their death, how to handle data in detail after they die, as in a written will which settles, for example, that data X is returned to a recipient A and data Y is returned to a recipient B.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating a function of an information processing apparatus according to an embodiment.

FIG. 2 is an exemplary view for explaining the outline of processing for setting of data transfer at the time of death included in a flow of data return performed when a data holder has died, this processing being included in data storage services provided by the information processing apparatus of the embodiment.

FIG. 3 is an exemplary view illustrating an example of a screen provided by the information processing apparatus of the embodiment for accepting designation of a recipient at the time of death.

FIG. 4 is an exemplary view illustrating an example of a screen provided by the information processing apparatus of the embodiment for providing information used when a recipient is registered.

FIG. 5 is an exemplary view illustrating an example of a screen provided by the information processing apparatus of the embodiment for enabling a person designated as a recipient to accept that they become the recipient.

FIG. 6 is an exemplary view illustrating an example of a screen provided by the information processing apparatus of the embodiment for enabling recipient selection when return data is designated.

FIG. 7 is an exemplary view illustrating an example of a screen provided by the information processing apparatus of the embodiment for enabling setting of authority to be imparted to a recipient for each data item when return data is designated.

FIG. 8 is an exemplary view for explaining the outline of processing for data transfer at the time of death included in a flow of data return performed when a data holder has died, this processing being included in the data storage services provided by the information processing apparatus of the embodiment.

FIG. 9 is an exemplary view illustrating an example of a screen provided by the information processing apparatus of the embodiment for enabling uploading of an identification paper.

FIG. 10 is an exemplary view for explaining an operation of a recipient performed on return data in the data storage services provided by the information processing apparatus of the embodiment.

FIG. 11 is an exemplary flowchart illustrating a flow of data transfer setting processing at the time of death, included in the data storage services provided by the information processing apparatus of the embodiment.

FIG. 12 is an exemplary flowchart illustrating flow of data transfer processing at the time of death, included in the data storage services provided by the information processing apparatus of the embodiment.

### DETAILED DESCRIPTION

Various embodiments will be described hereinafter with reference to the accompanying drawings.

In general, according to one embodiment, an information processing apparatus provides a data storage service via a network for storing data of a user. The apparatus includes a recipient setting module and an account issuing module. The recipient setting module is configured to accept and set a recipient of data and recipient-receivable data, designated by the user. The account issuing module is configured to issue an account to the recipient set by the recipient setting module. The account has an access right for enabling the recipient to access the recipient-receivable data.

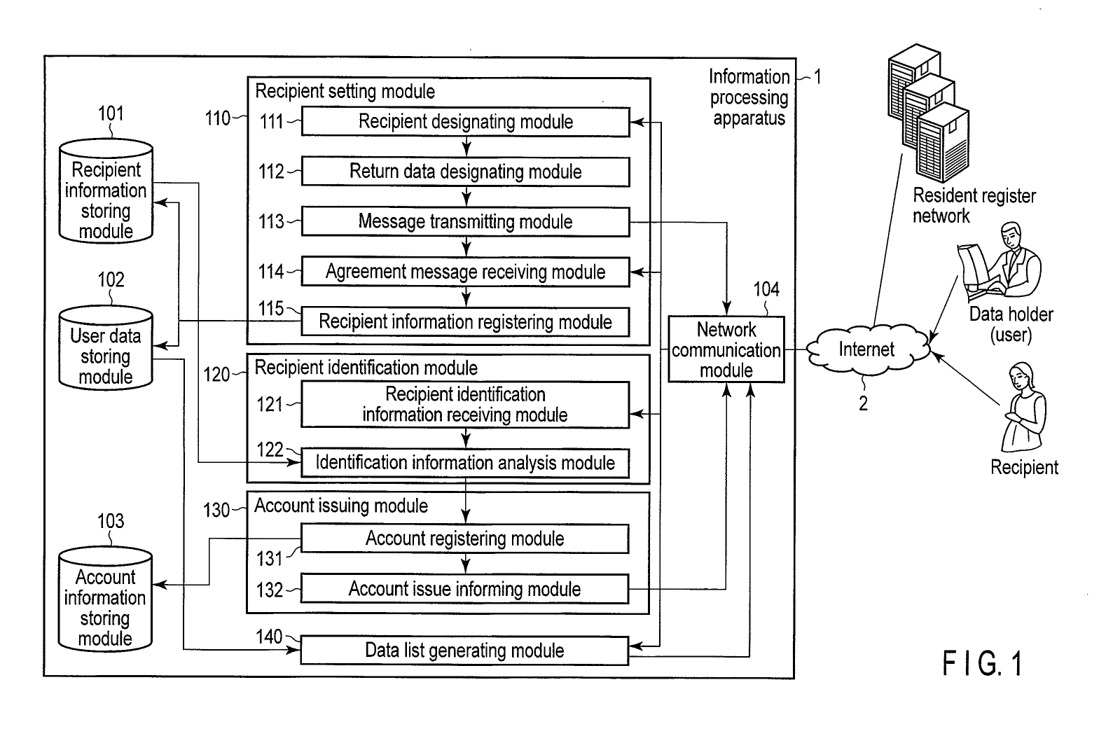

FIG. 1 is an exemplary block diagram illustrating a function of an information processing apparatus 1 according to an embodiment. The information processing apparatus 1 is a computer used as a server configured to provide, through the Internet 2, data storage services for storing user data. FIG. 1 shows a function included in those of the server configured to provide data storage services, and associated with data returned when a date holder has died.

As shown in FIG. 1, the information processing apparatus 1 includes a recipient information storing module 101 configured to store information associated with a target (a person or an artificial person) designated as a recipient by a user, a user data storing module 102 configured to store information associated with data stored in this service, an account information storing module 103 configured to manage information on the accounts who can access the service, and a network communication module 104 that communicates with, for example, a user or a recipient (or an electronic device used by the user or recipient) through the Internet 2.

The information processing apparatus 1 further includes a recipient setting module 110 configured to set a target to which data held by a user is returned when the user has died, a recipient identification module 120 configured to identify whether the target accessed the service is the person who was set as the recipient, an account issuing module 130 configured to set an account for accessing the service, and a data list generating module 140 configured to generate a list of data held by a user based on user's setting, and return the list to the recipient designated by the user.

The recipient setting module 110 includes a recipient designating module 111 configured to designate a recipient of the held data, a return data designating module 112 configured to designate data returned to a target designated as the recipient, a message transmitting module 113 configured to transmit, to the target, a confirmation message for confirming whether the target designated as the recipient is a genuine recipient, an agreement message receiving module 114 configured to receive an agreement message from the recipient target, and a recipient information registering module 115 configured to register information associated with the recipient in the recipient information storing module 101.

The identification module 120 includes a recipient identification information receiving module 121 configured to receive identification information from the recipient, and an identification information analysis module 122 configured to analyze the identification information received from the recipient and correlate it with the registered information.

The account issuing module 130 includes an account registering module 131 configured to register an account appropriately set, in the account information storing module 103, for the recipient for enabling the recipient to access the service, and an account issue informing module 132 configured to inform the recipient that an account has been issued.

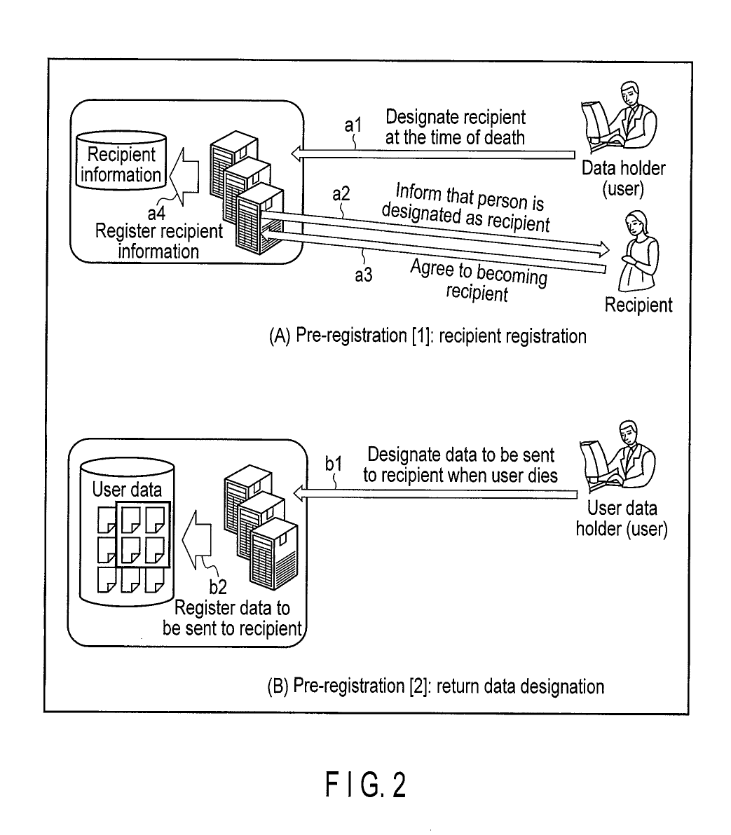

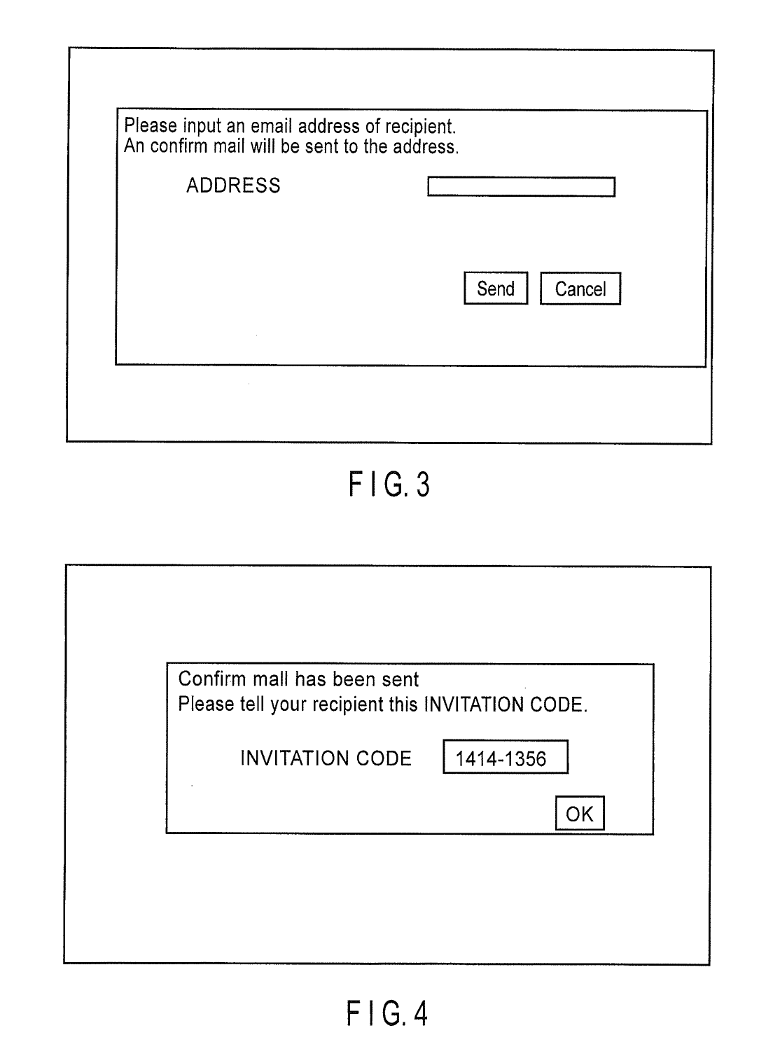

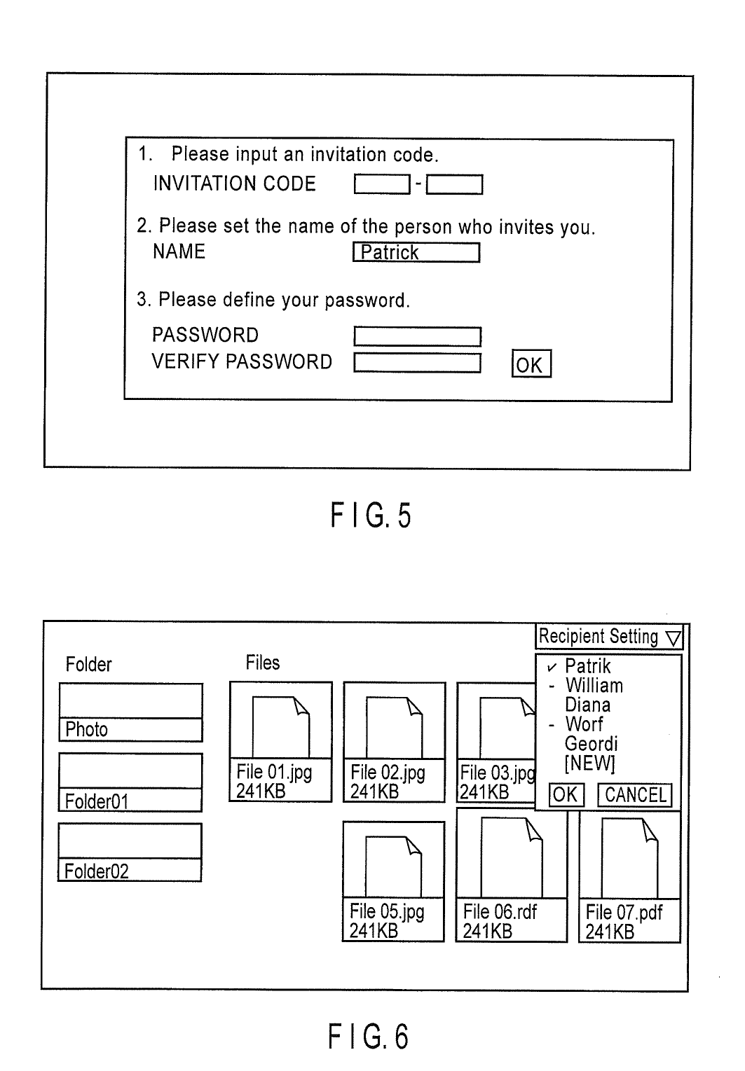

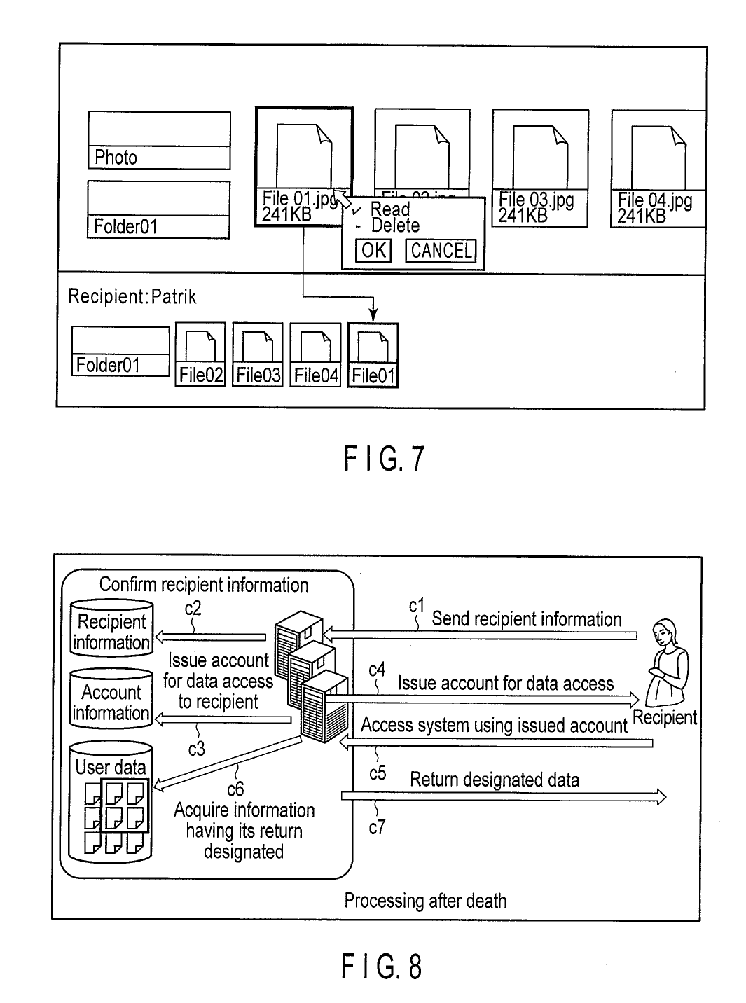

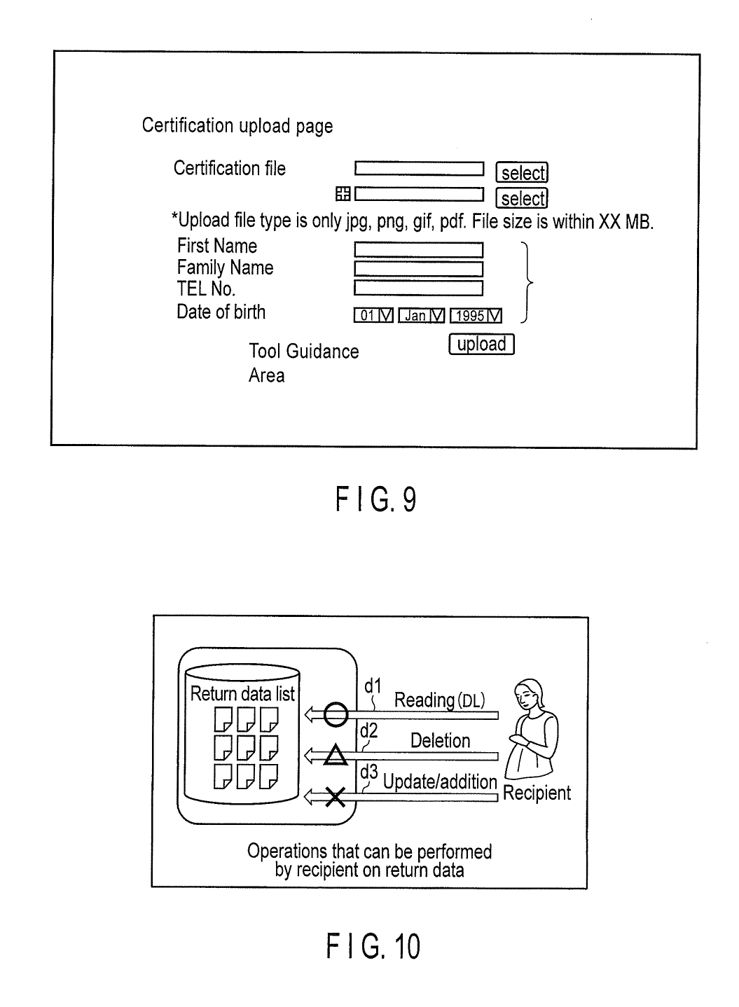

The data return flow of the service when a data holder (user) has died basically includes data transfer setting processing performed as pre-processing at the time of death, and data transfer processing performed to return data when the user has died. Referring first to FIG. 2, FIG. 3, FIG. 4, FIG. 5, FIG. 6 and FIG. 7, a description will be given of the outline of the data transfer setting processing at the time of death, and referring then to FIG. 8, FIG. 9 and FIG. 10, a description will be given of the outline of the data transfer processing at the time of death.
(a) Data transfer setting processing at the time of death

As shown in FIG. 2, the data transfer setting processing at the time of death includes two pre-registrations of recipient registration ((A) of FIG. 2) and return data designation ((B) of FIG. 2).

In the recipient registration, firstly, a user designates a recipient upon user's death (a1 of FIG. 2). FIG. 3 shows an example of a screen supplied from the information processing apparatus 1 as a server for providing this service to a user to enable the user to accept recipient designation at the time of user's death. This screen is provided as, for example, a web page, and displayed by a browser that operates in an electronic device used by the user. The same can be said of other screens provided to the user or recipient in the service. On the screen, the user inputs a mail address assigned to a person designated as the recipient, and transmits the resultant data to the information processing apparatus 1.

Upon accepting this designation, the information processing apparatus 1 generates information used to register the designated person as the recipient, and presents it to the user. FIG. 4 shows an example of the screen provided to the user to present the information used to register the recipient. The value “1414-1356” shown in column “INVITATION CODE” on the screen of FIG. 4 is the information generated as the information used to register the recipient and presented to the user. By operating the “OK” button on the screen, the user informs the information processing apparatus 1 that the value “1414-1356” is received.

The user transmits the value “1414-1356” to the person designated as the recipient by some means. Upon receiving, from the user, a message that the value “1414-1356” has been informed of, the information processing apparatus 1 informs the person that they /have been designated as the recipient by the user (a2 of FIG. 2) by transmitting email to the mail address accepted through the screen shown in, for example, FIG. 3.

The email transmitted to the person designated as the recipient contains a uniform resource locator (URL). If the person consents to be the recipient, they express their will by using this URL (a3 of FIG. 2). FIG. 5 shows an example of a screen to be provided to the person designated as the recipient, in order to enable them to express their will.

In the screen shown in FIG. 5, the recipient inputs the information transferred from the user, i.e., the value “1414-1356”, through a column “INVITATION CODE”, inputs the user's name through a column “NAME”, inputs their password through columns “PASSWORD” and “VERIFY PASSWORD”, and then operates an “OK” button, thereby transmitting these input information items to the information processing apparatus 1. Upon receiving the information items, the information processing apparatus 1 specifies, from the value “1414-1356”, which user designated the recipient, and registers the received data as recipient information (a4 of FIG. 2).

Further, in the return data registration, the user designates data to be transferred to the recipient upon user's death (b1 of FIG. 2). The user can designate a plurality of recipients, and can designate return data for each recipient. Firstly, the user operates a command button “Recipient Setting” provided on the upper end of the screen to select a recipient as a destination of return data, as is shown in FIG. 6. In the example of FIG. 6, “Patrik”, “William”, “Diana”, “Worf” and “Geordi” are designated as recipients, and “Patrik” is selected. Further, if an item [NEW] is selected and then the “OK” button is operated, the screen shown in FIG. 3 is displayed to enable designation of a new recipient.

For instance, if “Patrik” is selected and then the “OK” button is operated, such a screen as shown in, for example, FIG. 7 is displayed to enable data returned to Patrik to be designated. As shown in FIG. 7, firstly, the user can designate the data to be returned to the recipient selected in FIG. 6. Secondly, the user can designate whether only reading is allowed for each designated data item, or deletion is also allowed for it. A default indicates the allowance of only reading. If a “Delete” column is checked, deletion is also allowed. The information processing apparatus 1 stores the content designated through FIG. 6 and FIG. 7 (b2 of FIG. 2).

The above is the outline of data transfer setting processing at the time of death.
(b) Data transfer processing at the time of death

In the data transfer processing at the time of death, as shown in FIG. 8, firstly, the recipient transmits recipient information for this service (c1 of FIG. 8). FIG. 9 is an exemplary view illustrating an example of a screen provided by the information processing apparatus 1 for enabling uploading of an identification paper as recipient information.

In the screen shown in FIG. 9, the recipient inputs, in a column “Certification file”, an image file obtained by scanning a user death certificate, and an image file obtained by scanning a recipient's identification document. Further, the recipient inputs their name, phone number, birthday, etc. (as additional information for identifying the recipient themselves). After inputting these data items, the recipient operates an “upload” button to transmit them to the information processing apparatus 1.

The information processing apparatus 1 executes confirmation operation of the recipient information received from the recipient (c2 of FIG. 8). For instance, the apparatus performs image recognition processing on the image file corresponding to the user death certificate to thereby identify the user, and accesses the Resident Register network shown in FIG. 1 through the Internet 2, thereby verifying the user death certificate. Verification of a death certificate utilizing the Resident Register network is merely an example and is not indispensable. The information processing apparatus 1 performs image recognition processing on, for example, the image file corresponding to the recipient identification document to confirm that the recipient is a genuine one designated by the user, also utilizing the additional information.

After confirming that the recipient satisfies the conditions for receiving returned data due to the death of the user, and that the recipient is a genuine one designated by the user, the information processing apparatus 1 issues an account for data access to the recipient (c3 and c4 of FIG. 8). Using the issued account, the recipient accesses the system (c5 of FIG. 8). The information processing apparatus 1 acquires the data designated to return (c6 of FIG. 8) and returns it to the recipient (c7 of FIG. 8).

As mentioned above, regarding the returned data, the recipient is basically allowed to read (d1), and may be allowed to delete (d2) if the user allowed deletion. However, updating and addition are totally unallowable (d3).

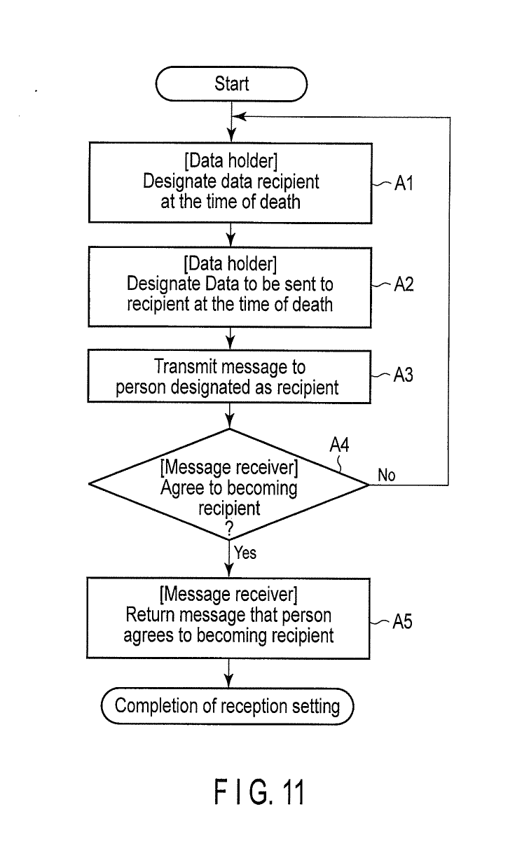

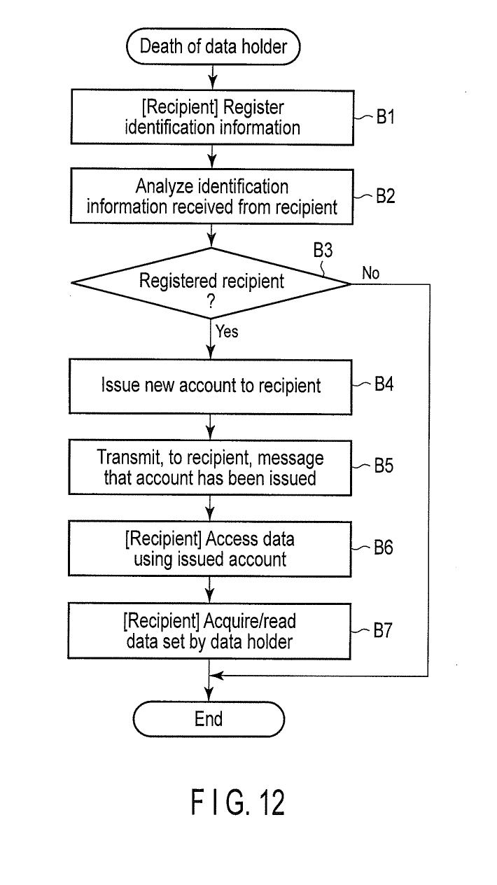

Referring then to FIG. 11 and FIG. 12, a detailed description will be given of the flow of data return performed in the service when a data holder has died. FIG. 11 is an exemplary flowchart illustrating a flow of data transfer setting processing at the time of death, included in the data storage services. FIG. 12 is an exemplary flowchart illustrating a flow of data transfer processing at the time of death.

In the flow of data transfer setting processing at the time of death shown in FIG. 11, processing is basically performed to the recipient setting module 110. The user designates, to the recipient designating module 111, the person(s) to whom the data stored in the storage services should be returned (block A1). In this designation, a mail address, for example, is designated as information that can be sent from the information processing apparatus 1 to a recipient. After designating the recipient, the user designates, to the return data designating module 112, which data in their stored data items should be returned to the designated recipient (block A2). After the return data is designated, the message transmitting module 113 transmits, through the network communication module 104 and the Internet 2, a message that you are designated as a recipient to the person designated by the recipient designating module 111 (block A3).

From this message, the target designated as the recipient knows that they are designated as the same. If the target agrees to becoming a recipient (Yes in block A4), they register, to the agreement message receiving module 114, information indicative of agreement and recipient information by a preset method described in the transmitted message (block A5). As the method for realizing the agreement message receiving module 114, return of a message, for example, is possible, as well as the above-mentioned method of guiding an agreement message to, for example, a browser, using a predetermined URL embedded in the message, and then permitting the message to be registered. If a recipient rejects or neglects a message (No in block A4), recipient designation processing is re-executed, beginning with the first block of the flow.

When the recipient registers the information to the agreement message receiving module 114, the recipient information registering module 115 records, in the recipient information storing module 101, the information on the recipient designated at the recipient designating module 111, and the information recorded by the recipient, and also records, in the user data storing module 102, the information on the return data designated at the return data designating module 112.

In contrast, in the data transfer processing at the time of death shown in FIG. 12, after confirming the information indicating the death of the user who has data, the recipient accesses the recipient identification module 120 for proving that the recipient is a genuine one designated by the user.

The recipient transmits the identification information to the recipient identification information receiving module 121 (block B1). The recipient identification module 120 transmits the received identification information of the recipient to the identification information analysis module 122. The identification information analysis module 122 compares the information stored in the recipient information storing module 101 with the identification information transmitted by the recipient (block B2). If these information items match each other (Yes in block B3), The identification information analysis module 122 sends information indicating that identification is finished to the account issuing module 130. In contrast, if they do not match each other (No in block 33), it is determined that identification processing has failed to thereby terminate the flow.

As described above, the identification information preferably contains information used to prove the death of the user, as well as the information indicating that the recipient is a genuine one. The identification information analysis module 122 accesses, for example, the Resident Register network shown in FIG. 1 through the network communication module 104 and the Internet 2, to verify the information transmitted from the recipient for proving the death of the user.

Upon receiving the information indicating the completion of the identification processing, the account issuing module 130 stores, in the account information storing module 103, account information that enables the recipient to access the data registered as return data by the user who designated the recipient (block B4). This account is issued as a limited account that basically allows reading of designated data, but does not allow changes, such as addition, updating and deletion, in the data held by the user. Only when deletion of data is exceptionally designated by the user, an account allowing deletion of data is issued.

The account issue informing module 132 transmits a message indicating issuing of an account to a contact address registered in association with the recipient (block B5). The recipient accesses services using the issued account (block B6). To the recipient having accessed the services, the data list generating module 140 presents a list of return data items for the recipients stored in the user data storing module 102. The recipient can read data items presented by the data list generating module 140 (block B7).

The process of returning data to the recipient when the user using the data storage services has died is finished by the above procedure.

By the above-described process of designating a recipient, the data held on a cloud (Internet 2) can be returned to the recipient (third person) designated by a user, regardless of the content of the data, and can be prevented from being accessed by those other than the designated recipient.

Further, the data to be returned can also be designated by the user, which enables return of each of a large number of data items to be designated.

In addition, the above-described account issuing and identification mechanisms enable system managers to detach from data transmission and reception, with the result that leakage of data on the management side can be avoided.

Furthermore, most data used in the services, other than that returned to recipients, can be prevented from being accessed.

The recipient designation and return data designation at the recipient setting module 110 are not limited to the above-described order of processing. The procedure may be modified such that after a recipient is designated, return data is designated at appropriate timing in a step different from the recipient designation step.

Alternatively, no return data may be designated, and all data held by a user be returned.

Yet alternatively, the recipient identification module 120 may employ an identification method using a telephone or mail by a system provider, instead of transfer of identification information by the information processing apparatus 1.

Further, since the account is limited only to data reading by the above-described recipient designation and account issuing mechanisms, the data held by a user can be prevented from alteration, whereby a plurality of recipients can be designated during recipient designation, and different groups of data can be returned to different recipients.

Moreover, the operation control processing of the embodiment is free from, for example, report means at the time of death, and therefore a recipient can perform a data return procedure at an arbitrary timing after the death of a data holder within an allowable range of services.

As described above, the information processing apparatus 1 of the embodiment can appropriately perform data return that is included in data storage services and is to be performed when a data holder has died.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus providing a data storage service via a network for storing data of a user, the apparatus comprising:
a recipient setting module configured to accept and set a recipient of data and recipient-receivable data, designated by the user; and
an account issuing module configured to issue an account to the recipient set by the recipient setting module, the account comprising an access right for enabling the recipient to access the recipient-receivable data.

2. The apparatus of claim 1, wherein the recipient setting module comprises:
an informing module configured to inform the recipient designated by the user that the recipient has been designated as a data recipient;
an agreement accepting module configured to receive, from the recipient designated by the user, a declaration of intention that the recipient agrees to becoming the data recipient; and
a registration module configured to register the recipient agreed to becoming the data recipient, along with identification information indicating the recipient-receivable data.

3. The apparatus of claim 2, wherein:
the informing module is configured to send, via the network, email for informing that the recipient has been designated as the data recipient; and
the recipient setting module is configured to accept the declaration of intention that the recipient agrees to becoming the data recipient by receiving, via the network, return mail of the email sent by the informing module, or to accept the declaration of intention that the recipient agrees to becoming the data recipient by exchanging data via the network, utilizing a web page indicated by a uniform resource locator (URL) described in the email sent by the informing module.

4. The apparatus of claim 1, further comprising a recipient identification module configured to identify that the recipient is set by the recipient setting module and satisfies a condition for permitting the account issuing module to issue the account.

5. The apparatus of claim 4, wherein the recipient identification module is configured to receive information proving death of the user and information identifying the recipient, and to verify whether the recipient is set by the recipient setting module and satisfies the condition for permitting the account issuing module to issue the account.

6. The apparatus of claim 1, wherein the recipient setting module is configured to be capable of accepting a plurality of recipients designated by the user, and to be capable of accepting a plurality of recipient-receivable data items for the plurality of recipients designated by the user.

7. The apparatus of claim 1, wherein:
the recipient setting module is configured to be capable of accepting designation of a corresponding one of the recipients as to whether each recipient-receivable data item is to be deleted; and
the account issuing module is configured to issue an account to the recipient, the account comprising an access right which enables deletion of each data item designated as deletable by the user, and enables only reading of each recipient-receivable data item designated as non-deletable by the user.

8. The apparatus of claim 1, wherein the account issuing module is configured to set an expiration date for an issued account.

9. A data return method of an information processing apparatus providing a data storage service via a network for storing data of a user, the method comprising:
accepting and setting a recipient of data and recipient-receivable data, designated by the user; and
issuing an account to the recipient, the account comprising an access right for enabling the recipient to access the recipient-receivable data.

10. The method of claim 9, further comprising identifying that the recipient is the set recipient and satisfies a condition for permitting issuance of the account.

11. A computer-readable, non-transitory storage medium having stored thereon a computer program which is executable by a computer providing a data storage service via a network for storing data of a user, the computer program controlling the computer to function as:
a recipient setting module configured to accept and set a recipient of data and recipient-receivable data, designated by the user; and
an account issuing module configured to issue an account to the recipient set by the recipient setting module, the account comprising an access right for enabling the recipient to access the recipient-receivable data.

12. The medium of claim 11, the computer program further controlling the computer to function as a recipient identification module configured to identify that the recipient is set by the recipient setting module and satisfies a condition for permitting the account issuing module to issue the account.
